(19) United States
(12) Patent Application Publication
(10) Pub. No.: US 2007/0064420 A1
(43) Pub. Date: Mar. 22, 2007

(54) LED device with enhanced light output

(76) Inventors: Kee Yean Ng, Penang (MY); Wooi Kin Goon, Penang (MY); Thye Linn Mok, Mertajam (MY); Gim Eng Chew, Penang (MY); Janet Bee Yin Chua, Perak (MY); Rene P. Helbing, Palo Alto, CA (US)

Correspondence Address: AVAGO TECHNOLOGIES, LTD., P.O. BOX 1920, DENVER, CO, 80201-1920, US

(21) Appl. No.: 11/229,900

(22) Filed: Sep. 19, 2005

(51) Int. Cl. F21V 9/00

(52) U.S. Cl. 362/231

(57) ABSTRACT

An enhanced light output light emitting diode (LED) is constructed using a plurality of single domed LEDs with each dome acting as a lens. By packaging multiple LEDs, each with its own dome (lens), greater-light output can be achieved. In one embodiment, each individually domed LED is a single color and the mixed colors from the group of LEDs within a device yields white light output. In another embodiment, the phosphors within each dome are mixed to produce white light. Reflectors can be added to enhance light output.

### FIELD OF THE INVENTION

This invention relates to light emitting devices and more particularly to light emitting diode (LED) devices with enhanced light output.

### BACKGROUND OF THE INVENTION

It has become standard practice to use light emitting diodes (LEDs) as flash modules in mobile applications that have camera functions. For example, mobile phones or PDAs are increasingly equipped with camera modules for image capture and a flash module serves as an illumination source in low ambient light situations. These flash modules must produce a large amount of light each time they are activated.

One prior art device employs multiple LEDs in a single housing to produce the proper light output. These devices are not efficient in light output because they are not located at optimum positions relative to the dome profile which acts as a lens and because there is cross absorption of the light between the LEDs.

In another prior solution, a single LED is used to replace multiple LEDs. The drawback for using a single LED is that it requires a higher current and while the light output is higher, the actual photo extraction is less efficient. Consequently, light output is not optimized for power consumption.

### BRIEF SUMMARY OF THE INVENTION

An enhanced light output light emitting diode (LED) is constructed using a plurality of single domed LEDs with each dome acting as a lens. By packaging multiple LEDs, each with its own dome (lens), greater-light output can be achieved. In one embodiment, each individually domed LED is a single color and the mixed colors from the group of LEDs within a device yields white light output. In another embodiment, the phosphors within each dome are mixed to produce white light. Reflectors can be added to enhance light output.

### BRIEF DESCRIPTION OF THE DRAWINGS

For a more complete understanding of the present invention, reference is now made to the following descriptions taken in conjunction with the accompanying drawings, in which:

FIG. 1 illustrates one embodiment of a light enhanced LED using multiple LEDs each having an individual dome;

FIGS. 2 and 3 show embodiments of individual domed LED arrangements;

FIG. 4 shows one embodiment of a camera using the light enhanced LED device; and

FIG. 5 shows a prior art multi-LED device.

### DETAILED DESCRIPTION OF THE INVENTION

As discussed above, prior art flash devices, such as device 50 is shown in FIG. 5, has two LEDs, such as LEDs 53-1 and 53-2 contained within a single dome (LEDs) 54 all constructed on substrate 51. Reflectors 52 are used to direct the light out of the top of the device 50. LEDs 53-1 and 53-2 are constructed the same and one typical construction to achieve a white light output would be to fabricate the LED by surrounding a blue LED chip with a yellow YAG phosphor. In such devices, the phosphor serves to absorb a portion of the blue radiation and emits a yellow radiation. The combination of the blue and yellow radiations yields white light. The device of the prior art is typically fabricated with the phosphor mixed with an encapsulate that surrounds the blue LED.

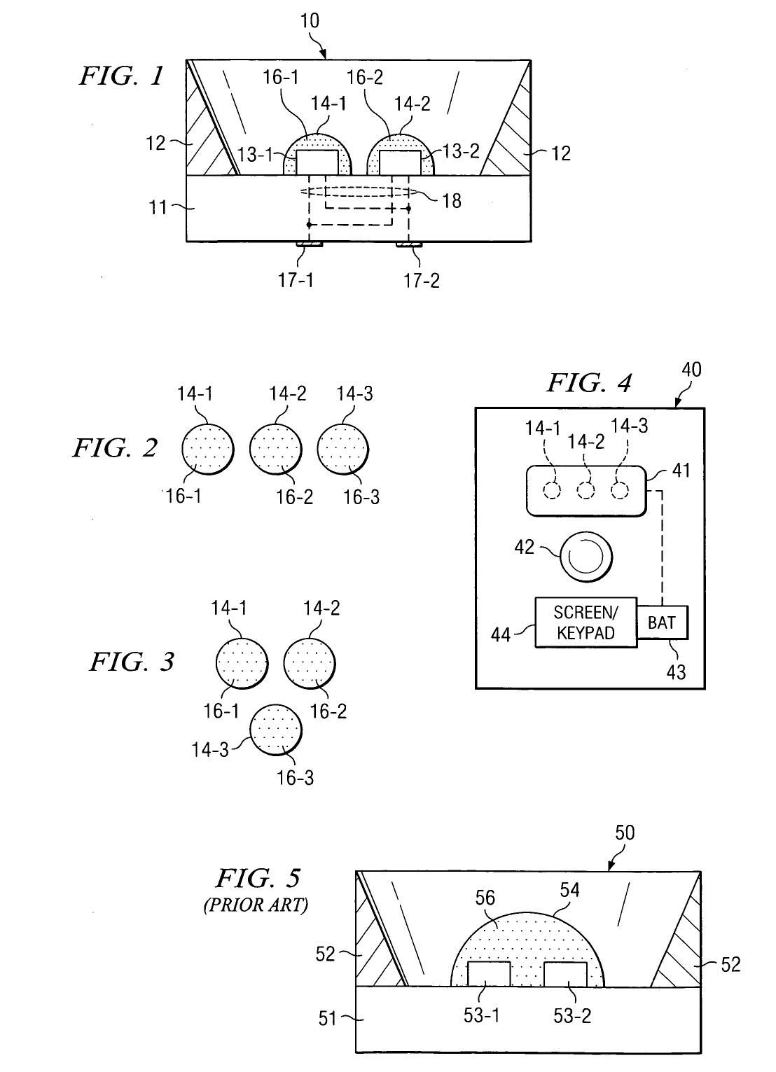

FIG. 1 illustrates one embodiment of light enhanced LED 10 having multiple LEDs, such as LEDs 13-1 and 13-2 with each LED having its own dome (lens) 14-1, 14-2 respectively. Each LED (13-1, 13-2) is placed in the optimum position within its own individual lens (14-1, 14-2). Light output is enhanced and there is little, or no cross absorption of light. The device is constructed on substrate 1 and can have reflectors 12 to enhance light output.

FIGS. 2 and 3 show embodiments of individual domed LED arrangements. FIG. 2 shows a plan view of three LEDs with individual domes 14-1, 14-2, 14-3 in a single row while FIG. 3 shows the plan view of three LEDs arranged in a triangular fashion. Any configuration of LEDs can be used depending upon the desired output, both as to color and as to light intensity (photon output). Note that to produce a white light output, these LEDs can be used as a group, one LED emitting red light, one LED emitting blue light and one LED emitting green light, with their respective domes focused at a point. Alternatively, a blue LED can be used in each with phosphors (or other material) changing the light to white (if white is the desired output color). Note that the arrangement of the LEDs within each device can be changed and the number can be more or less then shown. If multi-colored LEDs are used, more than one 3-color group can be used, if desired.

The individual domes can be fabricated using any known method such as transfer molding, injection molding, casting, spraying, ink-jet printing, vacuum printing, film printing, photolithography or any known mechanical or chemical methods.

The phosphor material is preferably embedded inside the dome. Diffusant or thixotropic agents can further be added both inside the individual domes and outside the domes to improve the uniformity of the light radiation.

Electrical terminals such as terminals 17-1, 17-2 connected by electrical traces 18 to LEDs 13-1, 13-2 and 13-3 (not shown), below the substrate, can be used to control the flash. In one embodiment, all the LEDs within a device would be used in common such that a single “pulse” of energy would cause them all to light in unison. However, if desired, the individual LEDs could be controlled independently, thereby allowing a user to adjust the intensity and perhaps the ultimate color of the light output.

FIG. 4 shows one embodiment 40 of a camera device using flash 41 having therein a plurality of individually domed LEDs all set to “flash” under control of battery 43. Lens 42 and screen/keypad 44 are just some of the other features of device 40.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A flash device comprising:
a substrate;
a plurality of individually domed LEDs mounted to said substrate; and
wherein said plurality of LEDs combine to provide light output upon application of a common pulse of energy to said plurality of domed LEDs.

2. The flash device of claim 1 further comprising:
a thixotropic agent around said individual domed LEDs.

3. The flash device of claim 1 further comprising:
a diffusant agent around said individual domed LEDs.

4. The flash device of claim 1 wherein each of said individually domed LEDs produce white light output.

5. The flash device of claim 1 wherein said individually domed LEDs are different colors, said colors combining under control of said common energy pulse to produce a desired output light color.

6. The flash device of claim 5 wherein said desired output light color is white.

7. The flash device of claim 5 wherein said different colors are red, blue and green.

8. A LED device comprising:
a plurality of LEDs, each LED having an individual lens for directing light created by said LED; and
a control point for controlling light output from said plurality of LEDs as a single light event.

9. The LED device of claim 8 further comprising:
a light reflector positioned around said LEDs to assist in directing light from said LEDs out of said LED device.

10. The LED device of claim 8 wherein said single light event is a flash of light.

11. The LED device of claim 10 wherein said single flash of light is white light.

12. The LED device of claim 11 wherein said white light is created by a conversion of blue light within each said LED.

13. The LED device of claim 11 wherein said white light is created by the combination of different colored light from said plurality of LEDs.

14. The method of constructing a flash module, said method comprising:
positioning a plurality of LEDs, each with its own lens within the confines of a device; and
connecting energy input terminals to said plurality of LEDs.

15. The method of claim 14 further comprising:
positioning around said plurality of LEDs a reflector for directing light from said LEDs toward a focal point of said LED.

16. The method of claim 14 further comprising:
positioning diffusant agents around said plurality of LEDs.

17. The method of claim 14 further comprising:
positioning thixotropic agents around said plurality of LEDs.

18. The method of claim 14 wherein said connecting comprises connecting the energy input terminals for each LED in parallel.

19. A camera comprising:
a flash device, said flash device comprising:
a plurality of LEDs having individual lens-through which light from said LED passes to the surface of said flash device; and
an input for receiving a pulse of energy for creating a flash of light focused from said plurality of LEDs.

20. The camera of claim 19 further comprising:
means for creating different colors of said flash of light.

21. A flash device comprising:
means for supporting a plurality of LEDs; and
means for individually focusing light output from each said LED.

22. The flash device of claim 21 further comprising:
means for controlling the common enabling of light output from said plurality of LEDs.
